(19) United States
(12) Patent Application Publication
(10) Pub. No.: US 2013/0000087 A1
(43) Pub. Date: Jan. 3, 2013

(54) CABLE END CONNECTION

(76) Inventors: Anita Finckh-Jung, Deggingen (DE); Sven Winter, Burgstetten (DE)

(21) Appl. No.: 13/634,360

(22) PCT Filed: Mar. 17, 2011
(86) PCT No.: PCT/EP11/54054

§ 371 Date: Sep. 12, 2012

(30) Foreign Application Priority Data
Mar. 17, 2010 (DE) 10 2010 011 792.7

(51) Int. Cl. F16G 11/12

(52) U.S. Cl. 24/458

(57) ABSTRACT

A cable-end connection (10) tor a cable (1), which is constructed from a plurality of intertwined filaments (2), comprises an end part (3) for installing or supporting the cable (1) and that is fastened to one end of the cable (1), a part that is fitted without a sleeve, made from a castable, curable material, and connected without additional mechanical-connecting elements in a form-fitting manner to the filaments (2) solely by being cast around or molded on.

### CROSS-REFERENCE TO RELATED APPLICATIONS

This is a “national stage” application of International Patent Application PCT/EP2011/054054 filed on Mar. 17, 2011 , which, in turn, claims priority to and benefit of the filing date of German Patent Application 10 2010 011 792.7 filed on Mar. 1, 2010.

### BACKGROUND OF INVENTION

1. Field of Invention

The invention relates to a cable-end connection that is used for, in general, installation and attachment of a fiber cable in various fields of application, and, in particular, connection of the cable on its cable end to additional mechanical-construction elements to, for example, facilitate a support of the cable in a bolt.

Various types of cable-end connections are known in the related art. For example, mechanical components are used in the case of so-called “cable locks,” In which the cable end is placed in the shape of a loop and then secured with screw terminals at an overlapping region. In contrast to such detachable cable-end connections, the invention relates to an undetachable cable-end connection.

Likewise, various solutions have been proposed as undetachable cable-end connections in the state of the related art, wherein all of these solutions require a rather high manufacturing expense and additional mechanical-structural elements. In the case of the so-called “Flemish eye,” the stranding of the filaments or wires is released and intertwined again in the form of a loop, wherein subsequently the cable sling thus formed is secured via metallic sleeves by crimping. In the case of another type of uudetachable cable-end connection, conical metallic sleeves are used into which the broom-shaped fanned-out cable end is inserted and fixed therein, with a metallic material or synthetic resin. The “holding” force is in the process produced—in particular, by the form-fitting clamping of the cone of the sleeve (i.e., through the transverse pressing as a consequence of the wedge action). Also in the ease of the latter type of cable-end connection, different additional mechanical-construction elements are necessary for different applications (i.e., prefabricated sleeves in different shapes and sizes). Moreover, the casting of the cable end in the interior of the sleeve with liquid metal is relatively difficult to accomplish. It also requires specially trained personnel for this purpose to ensure the safety requirements of such cable-end connections.

In the case of these known cable-end connections, there is an additional problem to the effect that, in the case of specified “application” situations, a measurement of forces or other parameters is necessary. To this end, in the related art, expensive mechanical cable-end connections were used—for example, in the form of the above-described cable locks on which additional sensor components were mounted, from the outside (for example, to measure the “load” state on the cable-end connection and of the cable itself during operation).

Thus, there is a need in the related art for a cable-end connection that can be produced with the smallest possible number of construction elements with, however, a higher resilience and, in particular, high tensile strength for all diameter ranges, wherein the easiest possible integration of sensor elements for the recording of different operational parameters should be made possible.

### SUMMARY OF INVENTION

The invention overcomes the problems in the related art in a cable-end connection for a cable that is constructed fern a plurality of intertwined wires or filaments. The cable-end connection comprises an end part for installing or supporting the cable and that is fastened to one end of the cable, a part that is fitted without a sleeve, made from a castable, curable material, and connected without additional mechanical-connecting elements in a form-fitting manner to the filaments solely by being east around or molded on. The filaments are released from an original stranding assembly in a region of the end part and distributed essentially uniformly. The end part is produced in a casting mold by injection-molding, of synthetic resin, and the filaments are embedded and cast in a form-fitting manner around the material of the end part under pre-stress.

By casting around, or molding on with a castable, curable material, the shape of the end part can be essentially randomly selected. As a result of the fact that the twines or filaments of the cable end originally intertwined are directly connected to the material of the end part by a casting or molding, a secure support of the cable end in the end part is ensured without additional mechanical-structural elements, such as crimp sleeves, screw terminals, or retaining sleeves being necessary. The strength (and, in particular, maximum resilience with forces) is, however, relatively high in the case of the invention in proportion to the cable tensile strength. The production of the cable-end connection is, moreover, relatively simple and, for example, does not require an expensive second intertwining of the filaments or fanning-out of the wires (as had to take place in the case of the so-called “Flemish eye” by specially trained personnel). Not least in the end past, which is made of a castable, curable material (such as plastic or other casting materials), a simple integration of additional components (such as sensor elements) can take place directly in the interior of the material of the end part. In this way, meaningful measurements of the “load” state, temperature, or similar parameters can be performed without having to mount sensor components from the outside in an extra step. Due to the direct casting or molding of the end part on the cable end, no additional components are required (such as sleeves or screw terminals)—which, on the one hand, reduces the number of parts and, with that, production costs, but not least represents a significantly lower manufacturing cost (since, for example, for crimp sleeves, special devices for the crimping to produce cable-end connections are necessary according to the related art).

According to an advantageous embodiment of the invention, the filaments of the cable end are fanned-out in the manner of a broom in the material of the end part and, in particular, essentially completely embedded therein. Through the broom-shaped fanning-out, the filaments of the cable end are distributed in the entire structure of the cast end part. Together with the concomitant spacing of the filaments and spaces produced thereby (that are closed by the material of the end part), in this way, a high-strength and permanent monolithic connection element for direct load transfer is produced. Through, the broom-shaped fanning of the filaments of the cable end, not least a broadening of the dimension of the end part vis-à-vis the diameter of the cable itself fakes place.

According to a further advantageous embodiment of the invention, the filaments of the cable are loosened from the original stranding or intertwining and essentially arranged in uniform distribution in the region of the end part. In this way, the most extensive possible form-fitting connection to the material of the end part is ensured. The untwisted wires or filaments can, according to this embodiment, also be purposefully concentrated regions of the end part so that, depending on the “application” case and load distribution in the end part, optimum, support and load absorption are ensured.

According to a further advantageous embodiment of the invention, reinforcement elements are provided in the interior of the cured material of the end part at least in areas. Different materials and elements known to a person skilled in the related art can be used as reinforcement elements. Advantageously, reinforcement elements and/or fibers are embedded into the material of the end part and cured together with it. For example, carbon or glass fibers can be used as reinforcement fibers, The embedded reinforcement elements permit a local area-by-area reinforcement of the material. According to an advantageous embodiment in this regard, the reinforcement elements axe arranged and aligned corresponding to the distribution and course of the forces, in the “load” state of the cable-end connection. The distribution and course of the forces in the “load” state can he influenced corresponding to the “application” case through the purposeful use of reinforcement elements in such a way that an overall high-strength cable-end connection can be provided.

According to a further advantageous embodiment of the invention, at least one sensor element for the recording of data can. be Integrated in the material of the end part. Further, there is the possibility of the integration of an “RFID” system, (“radio-frequency identification” system). Through a simple embedding of sensor elements with, for example, connection cables in the casting of the end part in a die, a direct integration of recording components can take place. Any sensors known to a person skilled in the related art can be used as sensor elements—in particular, temperature sensors, force sensors, strain gauge strips, and the like. In this way, the end part does not have to be provided with extra sensor components from the outside. The direct integration of sensor elements in the material of the end part has the additional advantage that more precise measurements can be performed on respective sensitive points at respective known weak points (depending on the shape of the end part). The monitoring of the cable-end connection—in particular, with, respect to the load, temperature, and stability—in operation can, in this way, be improved. Not least, the sensor elements are protected from damage and ambient conditions through, the direct embedding in the interior of the material of the end part of the cable-end connection.

According to a further advantageous embodiment of the invention, the end part is a closed grommet that exhibits a through-hole. In an embodiment, the through-hole exhibits a ring or a reinforcement sleeve that, for example, can be made of metal. In this way, a secure bolt connection can be produced with the invention. The sleeve for reinforcement of the through-hole prevents damage of the material of the end part due to friction forces (even in the event of longer operation of the cable-end connection with rotational movements. In the case of this shape of a cable-end connection as a closed grommet, the untwisted filaments or wires of the cable end are, in an embodiment distributed in “loop” shape in the material of the end part. In this way, similar to the “Flemish eye” known from the related art, a relatively high tensile strength, of the cable-end connection can be achieved without the expensive splicing of all filaments necessitated in the case of the “Flemish eye.”

According to a further advantageous embodiment of the invention, the end part of the cable-end connection is produced by injection-molding of synthetic resin in a die. This makes it possible to completely fill all of the spaces between the filaments and, with this, ensures a secure bond between the untwisted filaments and end part. According to an advantageous embodiment in this respect, the filaments are embedded in the material of the end part under pre-stress and east in a form-fitting manner. For this purpose, the untwisted filaments of the cable are inserted into the interior of the die and held there under pre-stress during the injection-molding. In this way, a purposeful and taut alignment of the filaments can be achieved, which farther improves the strength of the cable-end connection.

According to a farther advantageous embodiment of the invention, the untwisted or released filaments are arranged in pairs in the region of the end part and twisted with one another. After the bonding to the synthetic resin in the die, a greater strength is achieved in this way so that the maximum resilience of the cable-end connection is greater. The twisted ends of the filaments arranged in pairs can, in accordance with a further embodiment, be placed, around a sleeve in the end part in the shape of a loop. This embodiment is of advantage in the case of an end part with a sleeve opening and, thereby, achieves an ever greater strength in comparison to a simple (i.e., loop-less) embedding of the ends of the filaments.

According to a further advantageous embodiment of the invention, the ends of the filaments are held under pre-stress in the region of the end part during the casting in the die. By such a purposeful pre-stressing of the ends of the filaments, the desired arrangement and distribution of the cast ends of the filaments can be ensured. In addition, this measure prevents harmful redistributions of force or overlapping from occurring in the cable ends. A uniform application of force as well as the good connection and support of the ends of the filaments in the cast material of the end part are, thus, guaranteed. According to a further advantageous embodiment in this respect, both the ends of the filaments in the region of the end part as well as the cable itself are held under pre-stress during the casting in the die. As a result of this, the positioning of the filaments in the end part is improved, and art even greater tensile strength and, with, this, resilience of the cable-end connection are achieved.

In accordance with the invention, the pre-stressing of the cable and/or ends of the filaments can lie in a pre-defined range. Through this measure, the connection and sweating of the cable end is further improved. Greater forces can be transferred as a result. The pre-stress lies, in accordance with an advantageous embodiment, in a range of a minimum breaking load of 5% to 50% of the minimum breaking load of the cable or filaments. Experiments have yielded very good results in the case of these values, both in terms of the form closure between the parts of the cable-end connection as well as with respect to the maximum tensile strain, which can be realized with it.

Other objects, features, and advantages of the invention are readily appreciated as it becomes more understood, while the subsequent detailed description of at least one embodiment of the invention is read taken in conjunction with the accompanying drawing thereof.

### BRIEF DESCRIPTION OF EACH FIGURE OF DRAWING OF INVENTION

FIG. 1 shows a top view of an embodiment of a cable-end connection according to the invention;

FIG. 2 shows a lateral view of the embodiment of the cable-end connection according to the invention illustrated in FIG. 1;

FIG. 3 shows a sectional view of “III-III” of the embodiment of the cable-end connection, according to the invention illustrated in FIGS. 1 and 2;

FIGS. 4a and 4b show other respective embodiments of the cable-end connection according to the invention with different shapes of the end part;

FIG. 5 shows a schematic view of a method for producing an embodiment of a cable-end connection according to the invention; and

FIG. 6 shows a sectional view of another embodiment of the cable-end connection according to the invention.

### DETAILED DESCRIPTION OF EMBODIMENTS OF INVENTION

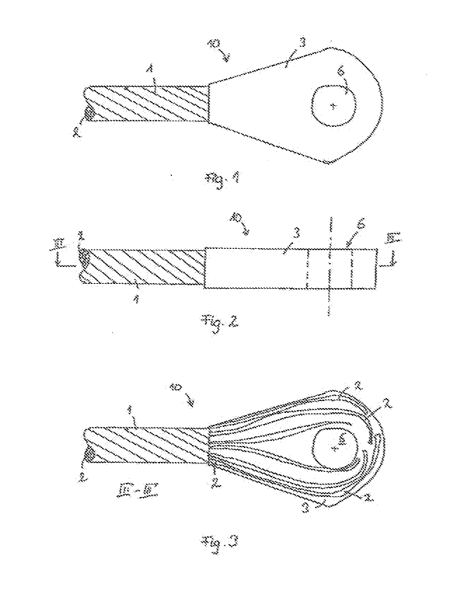

In FIGS. 1, 2 and 3, an embodiment of a cable-end connection of the invention is shown generally indicated at 10 in a top view, lateral view, and sectional view by way of illustration of the interior structure. The cable-end connection 10 exhibits, in the case of this embodiment, an end part 3 that is somewhat drop-shaped. The end of a cable 1 is provided with an end part produced, by casting of synthetic resin. The end part first conically expands to form on its end an expanded, somewhat circular region in which a through-hole 6 is formed. The through-hole 6 serves the purpose, for example, of receiving a clamping bolt for installation of tire cable at its mounting location. The cable 1 can be a plastic cable made of filaments 2 or twines. Other types of cables 1 can likewise be provided with the cable-end connection 10.

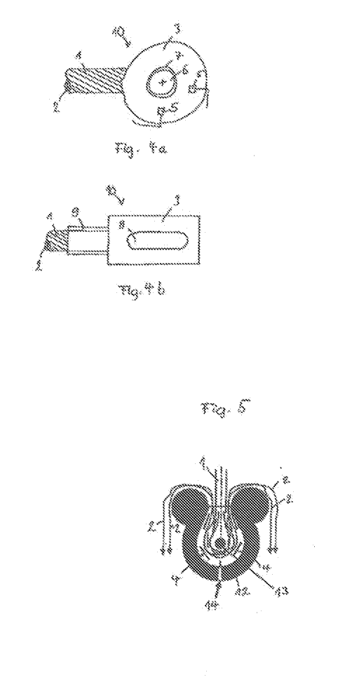

The cable-end connection 10 exhibits an end part 3 made of castable, curable material that is connected to the filaments 2 of the cable 1 without additional mechanical-connection elements by being cast around or molded on. To this end, on the cable end of the cable 1, the filaments 2 are unraveled and connected in naked form to the end part 3—for example, by a casting around in a die with a synthetic resin. The filaments 2 are, to this end and in suitable manner prior to the casting, placed in a die so that they exhibit an essentially uniform distribution over the entire width aid length of the end part 3. This can be seen from the schematic sectional view of FIG. 3. In this way, a cable-end connection 10 arises with high-strength properties. The cable-end connection 10 is extremely break-proof and exhibits a good “fatigue” limit even In the case of high loads. The cable-end connection 10, according to this embodiment, exhibits individual filaments 2 that are essentially uniformly apportioned in the interior of the material of the end part 3. The filaments 2 are, for this purpose, essentially aligned along the direction of the distribution of forces and load distribution at the somewhat drop-shaped end part 3 so that the filaments 2, to the greatest possible extent, follow the course of the load forces. In this way, even, high load peaks can be absorbed with the cable-end connection 10 without damage or failure. In other words, the cable-end connection 10 exhibits a high resistance to breakage. Along with the unraveled filaments 2 embedded in the material of the end part 3, additional elements can be in the synthetic resin during casting.

In accordance with an alternative embodiment of the invention, reinforcement fibers can he embedded in the end part 3. The fibers offer, together with the ends of the filaments 2 of the cable 1, an even greater strength of the cable-end connection 10.

In accordance with a further advantageous embodiment of the invention, sensor elements can also he integrated into the material of the end part 3 (in an embodiment, a curable synthetic resin). As sensor elements—for example, temperature sensors, force sensors, strain gauge strips, “RFID” circuits, or the like—can be embedded so that, with the relatively simply constructed and very compact end part 3 of the cable-end connection 10, data about the operating states and “fatigue” limit of a cable-end connection 10 and the high-strength tension, member can be recorded. The end part 3 mounted on the cable end of the cable 1 by casting of a castable, curable material can, for example, be produced by shape-casting or an injection-molding as known to a person skilled in the related art. The cable-end connection 10 does not require any additional mechanical components—such as sleeves, screw terminals, or cable locks—as they are used in the related art tor installing cables. The support and fixing of the end part 3 of the cable-end connection 10 is produced solely by die form-fitting easting around of the filaments 2 of the end part 3 of the cable 1. In this way, a very simply structured, cost-effective cable-end connection 10 is provided that is extremely compact in its exterior dimensions and can be randomly adapted to different “application” cases in the die.

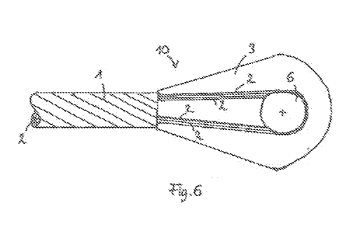

In FIGS. 4a and 4b, additional respective embodiments for the cable-end connections 10 are shown in schematic top views. FIG. 4a shows the cable-end connection 10 with an approximately circular end part 3 with a central through-hole 6. A sleeve 7—for example, made of metal—is inserted into the through-hole 6 to make possible a stable rotating connection to a bolt, for example. Also in the case of this embodiment, according to FIG. 4a, the filaments 2 of the cable 1 are unraveled on the cable end and embedded in the interior of the material of the end part 3, which is circular here via this embedding to produce a form closure with the end part 3. In the case of the embodiment of FIG. 4a, in addition, two sensors 5 are integrated in the end part 3 by placing them into the die during the casting of the synthetic resin. The sensors 5 can, for example, he a temperature sensor and force sensor and exhibit in each case schematically the connecting cables shown in FIG. 4a via which the recording signals can be forwarded to a control unit (not shown in the figure). With the sensors 5, respective temperatures and force relationships can be recorded during the operation of the cable-end connection 10 to, when required, replace the cable-end connection 10 or act on the load. With this and the cable-end connection 10, not only can a high-strength cable connection, be provided, but also, in this way, a permanent load monitor, temperature monitor, or monitor of the “fatigue” limit can be easily realized without having to mount separate sensor elements from the outside on the cable-end connection 10 or cable 1.

FIG. 4b shows in a schematic top view a further embodiment of a possible shape of the cable-end connection 10. This embodiment is characterised by an approximately rectangular end part 3 with a central oblong hole 8. In the transition region to the cable 1, a sheathing 9 (in an embodiment; made of the same material as the end part 3) is provided. Through the sheathing 9, the cable is protected from damage—in particular, an undesired breaking in this region. Also in the ease of this embodiment, the filaments 2 of the cable 1 are connected to the end part 3 by a direct casting in a synthetic resin. The cable-end connection 10, thus, does not require any additional installation elements (such as clamping sleeves or screw terminals) to couple the end part 3 of the cable-end connection 10 to the cable 1.

FIG. 5 shows in a schematic representation one possible embodiment of a method for producing the cable-end connection 10 with, an end part 3 made, for example, of synthetic resin. The cable 1 is placed with its unraveled filaments 2 in a die open at the top around a centrally provided holt or ring 13. The bolt or ring serves to produce a through-hole 6 in the end part 3. The unraveled filaments 2 are placed around the ring 13 and distributed essentially uniformly in the interior of the space of the die 12 so that sufficient spaces and distances between the filaments 2 result that are enclosed by the material that is subsequently injected. An injection opening 14 on the bottom is provided for insertion of the castable material. An injection of synthetic resin takes place via the opening. Prior to this, necessary reinforcement elements 4 (in an embodiment, in alignment along the line of force in the case of load) can be placed in the die 12 so that the end part 3 thus produced exhibits an even greater strength. In the case of this embodiment, according to FIG. 5, the filaments 2 are guided outward from, the die 12 and held under pre-stress during the casting. By the pre-stressing of the filaments 2 of the cable 1, on the one bands a purposeful alignment of the filaments in the material of the end part 3 of the cable-end connection 10 is achieved. On the other hand, the pre-stressing of the filaments 2 serves the purpose of preventing a relative displacement between the filaments 2 and cured end part 3 and, with this, an uneven load of the cable-end connection 10. Likewise, by the pre-stretching of the cable strand 1 during the pre-stressing operation, higher tolerable tensile strains in the casting material of the end part 3 are possible.

Alternative embodiments of the method for producing the cable-end connection 10 can likewise be used as long as the connection takes place by a casting-around or molding-on of the unraveled filaments 2 of the cable 1. Of course, the described features of the individual embodiments can also be combined with one another. This holds true, in particular, for the shape of the end part 3, use of reinforcement fibers 4, and location and alignment of the unraveled filaments 2 in the interior of the material of the end part 3.

In FIG. 6, a further embodiment of the cable-end connection 10 is shown in a sectional view similar to that of FIG. 3. In the ease of this embodiment, the ends of the filaments 2 are released from the stranding, twisted in pairs with one another, and then subsequently placed around the opening 6 or a sleeve in the opening 6. As a result, they form a type of “closed loop” shape in the cast material of the end part 3. In addition, the ends of the filaments 2 are placed under pre-stress during the casting operation so that they align essentially in a straight line. The cast filaments 2 axe, thus, arranged in the desired position and aligned. The ends of the filaments 2 can be cast alone live. As an alternative, both the cable and ends of the loop-shaped filaments 2 are placed trader a purposeful pre-stress as long as the synthetic resin has not yet cured. In an embodiment, the filaments 2 are essentially aligned in accordance with a distribution of forces in the case of the load of the cable-end connection 10 so that an oven better strength and high maximum-load absorption are achieved as a result.

The invention has been described above in an illustrative manner. It is to be understood that tire terminology that has been used above is intended to be in the nature of words of description rather than of limitation. Many modifications and variations of the invention are possible in light of the above teachings. Therefore, within the scope of the appended claims, the invention may be practiced other than as specifically described above.

1. A cable-end connection (10) for a cable (1) that is constructed from a plurality of intertwined filaments (2), the cable-end connection (10) comprising:
an end part (3) for either of installing and supporting the cable (1) and that is fastened to one end of the cable (1) a part that is fitted without a sleeve, made from a castable, curable material, and connected without additional mechanical-connecting elements in a form-fitting manner to the filaments (2) solely by being either of cast around and molded on.

2. The cable-end connection (10) as set forth in claim 1, wherein the filaments (2) are fanned-out in a manner of a broom in the material of the end part (3).

3. The cable-end connection (10) as set forth in claim 1, wherein the end part (3) includes, at least in regions, a plurality of reinforcement elements.

4. The cable-end connection (10) as set forth in claim 3, wherein the reinforcement elements are arranged and aligned corresponding to distribution and course of forces in a “load” state of the cable-end connection (10).

5. The cable-end connection (10) as set forth in claim 1, wherein either of at least one sensor element (5) for recordation of data and an RFID component is integrated in the material of the end part (3).

6. The cable-end connection (10) as set forth in claim 1, wherein the end part (3) exhibits a closed, grommet with a central through-hole (6).

7. The cable-end connection (10) as set forth in claim 6, wherein the through-hole (6) is reinforced with a sleeve (7).

8. The cable-end connection (10) as set forth in claim 2, wherein the released filaments (2) are arranged in pairs in the region, of the end part (3) and twisted with one another.

9. The cable-end connection (10) as set forth in claim 8, wherein respective ends of the twisted filaments (2) are placed around a sleeve in the end part (3) in a shape of a loop.

10. The cable-end connection (10) as set forth in claim 9, wherein the respective ends of the twisted filaments (2) are held under the pre-stress in the region of the end part (3) during the casting in a die.

11. The cable-end connection (10) as set forth in claim 10, wherein both of the respective ends of the filaments (2) in the region of the end part (2) and cable (1) are held under the pre-stress during the easting in the die.

12. The cable-end connection (10) as set forth in claim 2, wherein the pre-stress of at least one of the cable (1) and respective ends of the filaments (2) lies in a defined range of a “minimum breaking” load, of about 5% to about 50%.

13. The cable-end connection (10) as set forth in claim 1, wherein the filaments (2) are released from an original stranding assembly in a region of the end part (3), distributed essentially uniformly, and embedded and cast in a form-fitting manner around the material of the end part (3) under pre-stress.

14. The cable-end connection (10) as set forth In claim 1, wherein the end part (3) is produced in a casting mold by injection-molding of synthetic resin.

15. The cable-end connection (10) as set forth in claim 2, wherein the filaments (2) are essentially completely embedded In the material of the end part (3).

16. The cable-end connection (10) as set forth in claim 3, wherein the end part (3) includes a plurality of reinforcement fibers (4) in an interior of the material.
